(19) United States
(12) Patent Application Publication
(10) Pub. No.: US 2002/0182957 A1
(43) Pub. Date: Dec. 5, 2002

(54) Durable interior decorative laminates

(75) Inventor: John L. Levenda, Bothell, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Boeing Company

(21) Appl. No.: 09/845,990

(22) Filed: Apr. 30, 2001

(51) Int. Cl. B32B 27/02; B32B 27/30; B32B 5/02; D03D 15/00; B32B 27/12; B32B 27/04

(52) U.S. Cl. 442/173; 442/181; 442/168; 442/179; 442/286; 442/288; 442/148; 428/908.8; 428/913.3

(57) ABSTRACT

An improved decorative laminate and method for making the improved decorative laminate having a protective layer, an embossable layer, and a substrate layer; the protective layer being a transparent tough resin material such as polyvinylidene fluoride (PVDF) with a design printed thereon, the embossable layer being a pigmented embossable resin, and the substrate layer being a fiber material. As a result of the pigmentation of the embossable layer, preferably with the predominant color of the design, scratches through the protective layer are not particularly noticeable since the pigmented embossable layer will be exposed which matches the predominant color of the design.

### FIELD OF THE INVENTION

This invention relates to decorative laminates, particularly to decorative laminates used within the cabin of an airplane.

### BACKGROUND OF THE INVENTION

Decorative laminates are widely used as surfacing materials for walls, countertops, furniture and other structures, such as aircraft interior panels. Decorative laminates are used in such structures because they can simulate the appearance of many materials, such as wood, and because laminates are capable of being molded and embossed to provide a three-dimensional surface. Decorative laminates are formed by a plurality of layers that typically include a substrate layer which might be embossable, a decorative layer that overlies the substrate layer, and a protective layer that overlies the decorative layer. Other layers may be included between the substrate, decorative and protective layers in specific decorative laminates, depending upon the nature of the materials used and the desired laminate characteristics. For instance, a thin metallic film may be provided between the substrate and the decorative layer in order to prevent chemicals released from the substrate from interacting with the decorative layer during curing of the laminate.

In recent years, the substrate layers of aircraft interior panel decorative laminates intended as rigid laminates have been formed of epoxy resin composites. Structurally, such laminates include decorative ink patterns or decorative sheets (e.g., a decorative layer) located between an epoxy resin composite substrate layer and a protective layer formed of a suitably transparent material such as polyvinyl fluoride. Conversely, the substrate layers of the laminates intended for use as flexible laminates have been formed of polyvinyl chloride and polyvinyl fluoride. Structurally, the flexible laminates are similar to the rigid laminates with the exception of the substrate layer. Both epoxy thermoset resins and polyvinyl chloride and polyvinyl fluoride thermoplastics form a readily embossable substrate layer of the laminate.

Embossment is ordinarily imparted to the laminate by a hot press process. During the press cycle, the laminate's thermosetting emboss resin is “molded” by the texture media (i.e., the textured press). The emboss resin is said to be molded because shear flow occurs within the thermosetting resinous material resulting in the layer's cross-sectional thickness variation, i.e., the creation of an embossed or textured surface. The hot press also “forms” the protective layer. The protective thermoplastic layer or film, usually Polyvinyl Fluoride (PVF), is said to be formed because its viscosity is too high for shear flow to occur, and thus cannot be molded and, although the film does stretch during forming onto the textured layer, the decorative film remains relatively uniform in thickness. Furthermore, the heat and length of the hot press cycle result in embossed resin curing or crosslinking, which effectively raises the embossed layer's viscosity and counteracts the residual stresses of the thermoplastic film layer during forming. The crosslinked embossed resin provides for texture retention within the laminate during any subsequent application processes with the pattern embossed into the substrate also being imparted to the decorative layer and the protective layer.

The decorative laminates are applied to the surfaces of structures within an airplane, such as walls, furniture, and cabinets, with use of an adhesive between the substrate of the laminate and the structure surface. Once applied, the laminate provides a protective and aesthetically pleasing covering for the cabinet, etc. The decorative layer of the laminate may be printed with a wide variety of patterns and colors, and the embossable layer of the laminate may be embossed to provide the laminate with texture. As such, the laminate is visually and tactilely pleasing to passengers on the airplane.

Because of the relatively durable PVF protective layer used on most laminates, the decorative laminates have a relatively long life span. However, the laminates do occasionally have to be replaced due to excessive wear and tear or during renovation of the airplane interior.

In the case of excessive wear and tear, the protective PVF layer and the decorative layer may be damaged, such as by being scratched, in one or more places to reveal the underlying substrate layer. By way of a common example, the decorative laminate applied to the side of the seats that face the aisle often times is scratched, sometimes deeply, by contact with luggage of the like. In this case, the substrate will show through to the surface and appear as an off-white mark or hole. If an excessive amount of wear and tear occur to a particular piece of laminate, that piece of laminate must be replaced.

Removal of previously installed decorative laminate from the interior of an airplane is a painstaking process. The adhesive connecting the back of the laminate with the surface of the airplane seat, cabin, etc. must first be weakened and then the laminate must be removed. In practice, removal of previously installed laminate is especially burdensome because the laminate breaks apart when pulled from the cabinet. In other words, the laminate tears easily upon removal, leaving small portions of unremoved laminate, and making removal of sheets of laminate particularly difficult. Difficulty of removal leads to increased labor costs and down time during the refurbishing of aircraft. A decorative laminate is therefore needed which does not reveal obvious signs of damage upon penetration of the protective layer and decorative layers of the laminate. Further, a decorative laminate is needed that provides for easy removal upon repair or renovation of the airplane.

### SUMMARY OF THE INVENTION

The present invention provides an improved decorative laminate and method for making the improved decorative laminate which utilizes an improved embossable layer to mask visual indications of otherwise obvious penetrations in the protective layers and decorative layers of the laminate. The ability to mask penetrations and other damage to the laminate helps the laminate remain visually pleasing for longer periods of time, thus lengthening the lifespan of the laminate. The improved laminate is also constructed so as to retain its structural integrity upon removal so that the laminate may be easily pulled from the surface which it covers.

The laminate is composed of three main layers: a substrate layer, an embossable layer, and a protective layer. The protective layer is a tough resin material, preferably a polyvinyl fluoride based material. The protective layer is transparent or semi-transparent. The embossable layer is a pigmented embossable resin, preferably a thermoset resin, which may be embossed to provide texture to the laminate. The embossable layer is preferably colored to match the color or the predominant color of the design. The substrate layer is a fiber reinforcement material. The substrate layer provides improved structural strength to the laminate. The layers are laminated together to form the improved decorative laminate.

The protective layer of the laminate is a clear or semi-clear layer of resinous material. The protective layer is preferably a thermoplastic material, and more preferably a polyvinyl fluoride based material such as polyvinyl fluoride (PVF) or polyvinylidene fluoride (PVDF). The protective layer has an outer surface that faces the environment and an inner surface laminated to the embossable resin material. A graphic design is printed upon the inner surface of the protective layer such that the design is viewable through the protective layer after lamination. In the case of text or specially oriented graphics, the graphics are reverse printed upon the inner surface of the protective layer so that the graphics appear “right side up” when viewed through the protective layer.

The embossable layer of the laminate is a pigmented embossable resin which is preferably a polyurethane, and alternatively a phenolic, a polyester, or a combination of any of the three. During or after lamination, a molding process molds a pattern into the embossable layer to provide the embossable layer, and therefore the overall laminate, with a texture. The embossable resin is pigmented or otherwise colored to match a color, preferably the predominant color, of the design printed upon the protective layer. Therefore, when the protective layer and design of the laminate is penetrated, the similarly colored embossed layer shows through rather than an off-white or nonmatching color from an embossed layer having no pigment. Scratches and damage to the invented laminate are much less apparent than similar scratches and damage on other laminates because damage to the invented laminate reveals the similarly colored embossed layer rather than an underlayer of contrasting color.

The substrate layer of the laminate is a fiber reinforcing material. The reinforcing fiber is preferably glass, aramid, carbon, or Kevlar TM, and most preferably glass. Furthermore, the preferred fiber reinforcing material is a woven layer of glass fibers. The fiber of the substrate is preferably not employed within a resin, though a fiber reinforced resinous material may also be used as the substrate. The preferred woven fiberglass substrate layer provides extra strength to the laminate, and prevents tearing of the laminate when stressed, such as when the laminate is being pulled away from an adhesive attachment to a solid surface. The fiber substrate enables the laminate to be pulled away from a surface after adhesive installation without coming apart, thus allowing for efficient removal of the laminate.

Because of the relatively simple arrangement of layers, lamination of the layers does not require any special processing. After printing the applicable design upon the protective layer and arranging the layers as specified above, the layers are laminated to one another under heat and pressure in accordance with those methods well known in the art. The layers are preferably laminated in a multiple opening press (MOP). Embossing of the embossable layer may occur during or after lamination, but preferably takes place simultaneously with lamination.

The invented decorative laminate solves problems associated with unsightly marks and scars caused by the penetration of the protective layers and decorative layers of the laminates by utilizing an embossable resin layer that is pigmented with a color similar to that of the design printed within the laminate. Thus, when the surface of the laminate is damaged, it simply reveals the embossed layer which has a similar color and therefore masks the defect. Also, the invented laminate is provided with a fiberglass substrate layer which provides strength to the laminate and allows the laminate to be peeled away from a surface after installation, so that the laminate may be easily removed and replaced. Further, the invented laminate has proven to be more scratch resistant than laminates of the past which utilized the well-known “double layer” of an ink layer sandwiched between two layers of PVF.

### BRIEF DESCRIPTION OF THE DRAWINGS

Having thus described the invention in general terms, reference will now be made to the accompanying drawings, which are not necessarily drawn to scale, and wherein:

FIG. 1 illustrates a conventional decorative laminate; and

FIG. 2 illustrates a decorative laminate in accordance with one embodiment of this invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

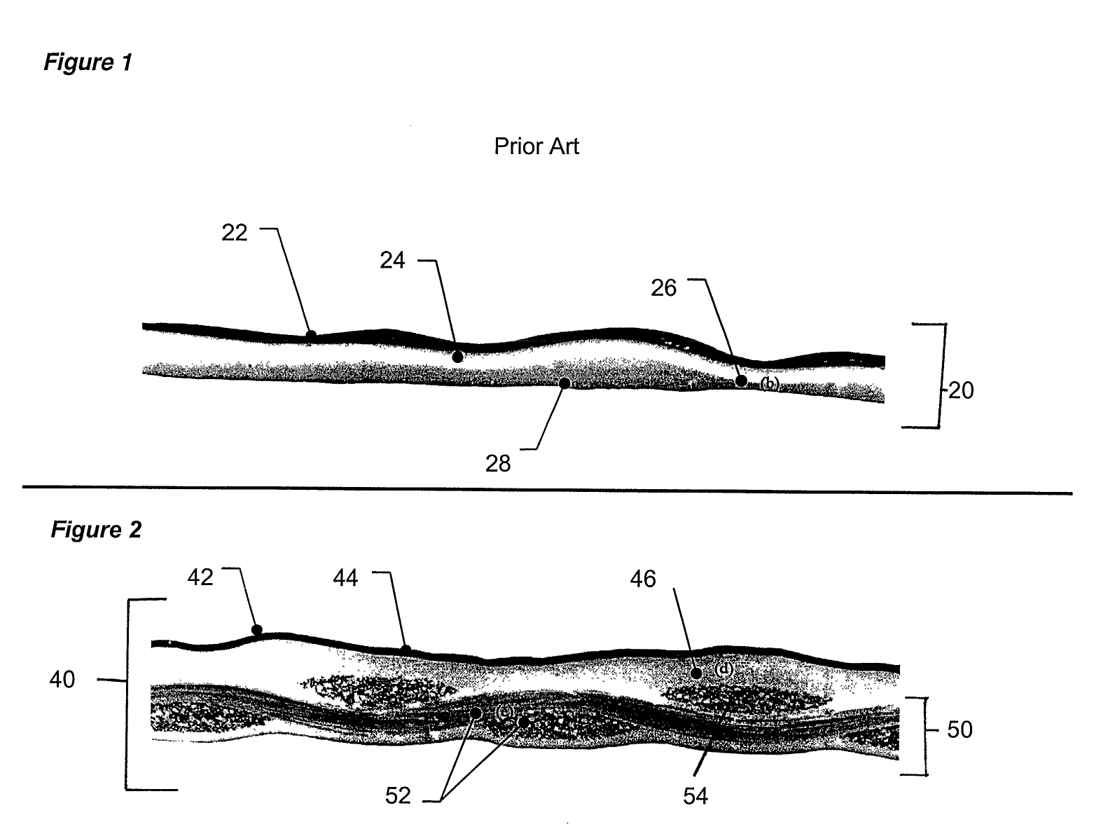

As illustrated in FIG. 1, decorative laminates 20 of the past have consisted of an ink layer 24 sandwiched between two PVF layers 22,26, all atop an embossable resin substrate 28. The embossable resin substrate 28 was typically a thermoset polymer such as an epoxy or polyester, capable of being molded and holding a textured pattern. The lower PVF layer 26 was usually an opaque PVF film, which could be pigmented, that provided a surface for printing and hid the underlying substrate 28 from view. A thin layer of ink 24 defining text, patterns, or other graphics was printed upon the lower PVF layer 26. Finally, an upper PVF layer 22 was laid atop the ink layer 24. The upper PVF layer 22 was transparent or semi-transparent and served as a protective layer.

As illustrated in FIG. 2, the improved laminate 40 is composed of three main layers: a substrate layer 50, an embossable layer 46 disposed on the substrate layer 50, and a protective layer 42 disposed on the embossable layer 46. It will be understood by those having skill in the art that when a layer is described as being “on” another layer, it may be formed directly on the layer or one or more intervening layers may be provided therebetween. The protective layer 42 is a tough resin material, preferably a polyvinyl fluoride based material which is transparent or semi-transparent. The embossable layer 46 is a pigmented embossable resin, preferably a thermoset resin, which may be embossed to provide texture to the laminate and which is colored to match the color or the predominant color of the design printed upon the protective layer 42. The substrate layer 50 is a fiber reinforcing material which provides improved structural strength to the laminate. The layers 42, 46, 50 are laminated together to form the improved decorative laminate 40.

The protective layer 42 of the laminate is a clear or semi-clear layer of resinous material. The protective layer 42 is preferably a polyvinyl fluoride based material. Polyvinyl fluorides are preferred because of their physical toughness, chemical inertness, abrasion and soil resistance, and consistency of character regardless of temperature changes. The polyvinyl fluorides are also able to receive a wide variety of inks used for printing graphics. As used herein, the term “polyvinyl fluoride-based material” refers to a polyvinyl fluoride polymer (i.e., a polymer formed from vinyl fluoride). The fluorinated polymer is generally a polymer, copolymer, or terpolymer of vinyl fluoride. The preferred polyvinyl fluoride polymers are polyvinyl fluoride (PVF) and polyvinylidene fluoride (PVDF). PVF is commercially available as Tedlar®, a trademark of E.I. DuPont de Nemours & Co., Wilmington, Del. PVDF is commercially available as Kynar®, a trademark of Elf Atochem. Various uses of polyvinyl fluoride films in laminates and the characteristics of the films are described, for example, in U.S. Pat. No. 3,397,108; U.S. Pat. No. 3,734,807; and, U.S. Pat. No. 3,340,137.

The protective layer 42 has an outer surface, which is typically exposed to and faces the environment, and an inner surface laminated to the embossable resin material. An ink layer 44 defining a graphic design is printed upon the inner surface of the protective layer 42 such that the design is viewable through the protective layer 42 after lamination. The protective layer 42 preferably has a thickness between about 0.2 mils and about 1.5 mils, more preferably between about 0.5 mils and 0.6 mils, and most preferably about 0.7 mils.

The invented laminate may be constructed without a printed ink layer 44, but the preferred laminate has a graphic design printed upon the inner surface of the protective layer 42, forming an ink or decorative layer 44. As the graphic of the improved laminate is printed upon the inner side of the protective layer 42 rather than printed on the top surface of an underlying layer 26 as done previously, the graphic often needs to be reverse printed so that the image will appear with the proper orientation when viewed from above. The PVF/PVDF layer is receptive to a wide variety of ink like coatings, with the preferred coating being an organic ink or paint. And, although any common industrial application capable of imparting ink to the inner surface of the protective layer 42 may be used, screen printing and, more particularly, reverse screen printing is the preferred method. Other acceptable methods of printing include laser screen printing, stenciling, ultraviolet electronic beam printing, flexographic silk screening, ink-jet printing, and the incorporation of a photograph or print.

The embossable layer 46 of the laminate is a pigmented embossable resin which is preferably a polyurethane, and alternatively a polyester, a phenolic, or a combination of any of the three. During or after lamination, a molding process molds a pattern into the embossable layer 46 to provide the embossable layer 46, and therefore the overall laminate, with a texture. The embossable resin 46 is pigmented or otherwise colored to match a color, preferably the predominant color, of the design printed upon the protective layer 42. Therefore, when the protective layer 42 and printed design 44 of the laminate is penetrated, the similarly colored embossed layer 46 shows through rather than an off- white or nonmatching color from a conventional embossed layer having no pigment. In previous laminates, the thin opaque PVF layer, the ink layer, and the upper PVF layer were easily damaged, resulting in unsightly scratches and scars. Scratches and damage to the invented laminate are much less apparent than similar scratches and damage on conventional laminates because damage to the invented laminate reveals the similarly colored embossed layer 46 rather than an underlayer of contrasting color. The embossable layer 46 preferably has a thickness between about 2.0 mils and about 8.0 mils, more preferably between about 4.0 mils and about 6.0 mils, and most preferably about 5.0 mils. Coloring of the embossable layer is preferably accomplished by pigmenting the liquid polymer mixture prior to casting, coating, or extruding the embossable layer.

Another advantage of using the pigmented embossable layer 46 is that an opaque PVF layer is no longer needed to visually hide the embossable resin or to provide a base colored layer beneath the printed design. Instead, the invention provides that the opaque PVF layer may be omitted and the printed design may be laminated directly above the colored embossable resin 46.

The substrate layer 50 of the laminate is a fiber reinforcing material. The reinforcing fiber 52 is preferably glass, aramid, carbon, or Kevlar TM, and most preferably glass. Further, the substrate 50 is preferably a layer of woven glass fibers. The preferred substrate 50 simply comprises a layer of woven glass fibers and does not have the fibers bound within a resin matrix, though a fiber reinforced resinous material may be used as a substrate in accordance with this invention. The fiberglass substrate layer 50 provides extra strength to the laminate, and prevents tearing of the laminate when stressed, such as when the laminate is being pulled away from an adhesive attachment to a solid surface. The fiber substrate 50 enables the laminate to be pulled away from a surface after adhesive installation without coming apart, thus allowing for efficient removal of the laminate, such as during replacement of the laminate.

In addition to the strength provided by the fiber substrate 50 identified above, the fiber substrate 50 imparts improved properties of scratch resistance to the overall laminate. The invented laminate not only has the ability to mask scratches and scars that would be apparent in previous laminates, but has improved resistance to scratches and scars, in general. The improved scratch resistance is believed to result from the improved structural strength of the laminate provided by the underlying fiber substrate 50.

Many varieties of the non-resin and resin impregnable fibrous materials and many manners of construction, all well known by those skilled in the decorative laminate art, can be used to create the substrate layer 50. The choice of resin impregnable fibrous material and the manner of construction primarily depend on the desired rigidity of the resulting laminate. Glass and paper fibers are often chosen when an inexpensive, relatively rigid laminate is desired. Such fibers are capable of imparting rigidity to a decorative laminate, while at the same time allowing the laminate to maintain a molded design or embossment.

Because of the relatively simple arrangement of layers, lamination of the layers does not require any special processing. After printing the applicable design 44 upon the protective layer 42 and arranging the layers as specified above, the layers are laminated to one another under heat and pressure in accordance with those methods well known in the art. The layers are preferably laminated in a multiple opening press (MOP). Embossing of the embossable layer 46 may occur during or after lamination, but preferably takes place simultaneously with lamination.

The decorative laminate may be used in a variety of applications. However, the use of the invented decorative laminate in commercial aircraft provides a laminate that may be applied to the interior surfaces of the aircraft to make the interior of the aircraft more visually and tactilely pleasing to passengers and crew. The invented laminate is more scratch resistant than previous laminates, resulting in large part from the protective layer of PVDF, a highly crystalline material which provides a harder surface than PVF, and also resulting from the improved overall structural integrity of the laminate provided by the fiber reinforcing layer. The laminate also uses a colored embossed layer to mask scratches and scars in the laminate when they do occur. Finally, the laminate has a reinforcing fiber substrate layer which greatly strengthens the laminate and which keeps the laminate from fragmenting upon extreme stress, such as while being pulled from a surface during removal of the laminate. Thus, the improved laminate is longer lasting than previous laminates, but allows for efficient removal when replacement is needed.

### EXAMPLES

The improved scratch resistance of the invented laminate and the improved visual appearance of the invented laminate after being abraded were demonstrated by comparison of the invented laminate with another commercially available laminate material.

The commercially available laminate was constructed in accordance with FIG. 1, with an embossing resin thickness of 3 mil, opaque PVF layer thickness of 2 mil, and clear PVF protective layer thickness of 1 mil.

In accordance with this invention, an example of the invented laminate utilized a substrate of 7628 fiberglass fabric reinforcement, a pigmented polyurethane embossing resin layer with thickness of 5 mil, and a clear PVDF protective layer with thickness of 0.7 mil.

Using liquid adhesives, the laminate samples were mounted upon a composite sandwich panel comprised of an aramid honeycomb core sandwiched between two layers of phenolic fiberglass skins. Total thickness of the sandwich panel was about 0.5 inches. Each sample was mechanically scraped with a pointed stylus. The mass of the mechanism housing the stylus was adjustable such that the pressure exerted upon the laminates could be measured. Results of the tests, measuring observed visual effects of the mechanical scratching are shown below.

| | | |
|---|---|---|
| Mass of Stylus | Effect on Surface | Visual Appearance |

Previous Laminate

| | | |
|---|---|---|
| 7 kg | Surface has a rippled appearance, | Deformation of surface is |
| | but not torn | noticeable |
| 8 kg | Large portion of the surface is torn | Obvious exposed white |
| | | embossing layer/substrate |
| 9 kg | Large portion of the surface is torn | Obvious exposed white |
| | | embossing layer/substrate |

Invented Laminate

| | | |
|---|---|---|
| 8 kg | Minimal surface damage | Small ripples are noticeable |
| 9 kg | Surface has a rippled | Small ripples are noticeable |
| | appearance, but not torn | |
| 10 kg | Majority of protective layer | Surface damage is apparent, but |
| | is abraded | exposure of underlying embossed |
| | | layer partially masks surface damage. |

As shown, the invented laminate was much more resistant to scratching than the previous laminate. Also, when the surface of the invented laminate was abraded, the exposed underlying pigmented embossed layer visually masked those portions of the protective layer that had been scraped away.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A decorative laminate comprising:
a substrate layer comprising a woven fiber material;
an embossable layer disposed upon said substrate layer, said embossable layer comprising a pigmented embossable resin; and
a protective layer comprising a polyvinyl fluoride-based material.

2. The decorative laminate of claim 1, further comprising an ink layer between said embossable layer and said protective layer.

3. The decorative laminate of claim 2, wherein the ink layer has a plurality of colors and the embossable resin has a pigmentation of one of the plurality of colors.

4. The decorative laminate of claim 2, wherein the ink layer has a predominant color and the embossable resin has a pigmentation of the same predominant color.

5. The decorative laminate of claim 1, wherein the substrate layer comprises fibers selected from the group consisting of glass, aramid, carbon, and Kevlar.

6. The decorative laminate of claim 1, wherein the embossable layer has a thickness between about 2 mil and about 8 mil.

7. The decorative laminate of claim 6, wherein the embossable layer has a thickness between about 4 mil and about 6 mil.

8. The decorative laminate of claim 1, wherein the protective layer has a thickness between about 0.2 mil and about 1.5 mil.

9. The decorative laminate of claim 8, wherein the protective layer has a thickness between about 0.5 mil and about 0.9 mil.

10. The decorative laminate of claim 1, wherein the embossable resin is selected from the group consisting of epoxies, polyesters, phenols, and combination thereof (any more?).

11. The decorative laminate of claim 1, wherein the fiber of the substrate material is embedded within a resin matrix.

12. The decorative laminate of claim 1, wherein the polyvinyl fluoride-based material is selected from the group consisting of polyvinyl fluoride and polyvinylidene fluoride.

13. A method of making a durable decorative laminate comprising:
printing an image on one side of a polyvinyl fluoride-based protective layer;
providing a pigmented embossable resin layer wherein the pigmentation matches at least one color of the printed image;
layering sequentially a woven fiber substrate layer, the pigmented embossable resin layer, and the fluoride-based protective layer, wherein
the printed side of the protective layer faces the embossable layer; and laminating the layers.

14. The method of claim 13, further comprising embedding the woven fiber within a resin matrix.

15. The method of claim 13, further comprising embossing the pigmented embossable layer concurrent with the lamination of the layers.

16. The method of claim 13, wherein printing further comprises reverse screen printing.

17. A decorative laminate comprising:
an embossable layer comprised of a pigmented embossable resin;
an at least partially transparent layer disposed upon said embossable layer; and
an ink layer disposed between said embossable layer and said protective layer, wherein the pigmentation of said embossable layer has a color that matches at least one color of the ink layer.

18. The decorative laminate of claim 17, wherein the ink layer has a predominate color and the pigmentation of the embossable layer is the same as the predominate color of the ink layer.

19. The decorative laminate of claim 17, further comprising a substrate layer comprising a woven fiber material disposed upon the embossable layer opposite of the ink layer.

20. The decorative laminate of claim 17, wherein the protective layer comprises a polyvinyl fluoride-based material.

21. The decorative laminate of claim 17, wherein the substrate layer comprises fibers selected from the group consisting of glass, aramid, carbon, and Kevlar.

22. The decorative laminate of claim 17, wherein the embossable resin is selected from the group consisting of polyurethanes, epoxies, polyesters, phenols, and combination thereof.

23. The decorative laminate of claim 17, wherein the woven fiber material is embedded within a resin matrix.

24. The decorative laminate of claim 17, wherein the polyvinyl fluoride-based material is selected from the group consisting of polyvinyl fluoride and polyvinylidene fluoride.
